(19) United States
(12) Patent Application Publication
(10) Pub. No.: US 2009/0131132 A1
(43) Pub. Date: May 21, 2009

(54) System and Method for the Processing, Display and Utilization of Wagering Data Concerning Parimutuel Evens

(76) Inventors: Lawrence Kohls, Winchester, MA (US); Sam Alwan, Glenview, IL (US)

Correspondence Address: BANNER & WITCOFF, LTD., 28 STATE STREET, 28th FLOOR, BOSTON, MA, 02109-9601, US

(21) Appl. No.: 12/273,678

(22) Filed: Nov. 19, 2008

Related U.S. Application Data
(63) Continuation of application No. PCT/US2007/069511, filed on May 23, 2007.
(60) Provisional application No. 60/808,189, filed on May 24, 2006.

(51) Int. Cl. A63F 9/24; A63F 13/00

(52) U.S. Cl. 463/6; 463/25

(57) ABSTRACT

Described is a system and method for the capture, storage, processing, manipulation, utilization and display of data regarding pari-mutuel events. Wagering information data streams obtained from conventional sources are captured, stored, manipulated and processed to yield derivative data that can be displayed in alphanumeric and/or color-coded graphical representations and/or utilized in real-time. The displays and associated data generated by the system empower a user to create, display, store, and back-test wagering strategies and algorithms, including wagering algorithms that may be automatically effectuated by the system to generate actual bets and to calculate profit and loss for each bet, runner and event.

### CROSS-REFERENCE TO RELATED APPLICATIONS

This application is a continuation of PCT Application No. PCT/US2007/069511 filed 23 May 2007, which was published in the English language on Dec. 6, 2007 as International Publication No. WO 2007/140194. The PCT Application claims priority from U.S. Provisional Application Ser. No. 60/808,189, filed May 24, 2006. The disclosures of these applications are hereby incorporated herein by reference.

### FIELD OF THE INVENTION

The invention relates to systems and methods for providing persons interested in wagering on pari-mutuel events with displays of information concerning odds and sums wagered. In particular the present invention is a system that employs currently available streams of pari-mutuel wagering data to provide users with alpha-numeric and color-coded graphical displays, dynamically updated frequently, of data concerning fluctuations in odds, amounts wagered, and other values derived from such data. In addition the present system provides users with means to utilize such processed wagering data to develop and employ wagering strategies and algorithms.

### BACKGROUND OF THE INVENTION

Pari-mutuel betting is the traditional form of wagering employed worldwide in track racing events such as horse racing, and it has been in use for centuries. At the conclusion of a racing event, those persons who hold winning tickets divide the total amount bet in proportion to their wagers, less a house percentage (which guarantees a specific return to the racetrack). It is a characteristic feature of pari-mutuel wagering that, as bettors place their bets in the period preceding each race (typically 30 to 45 minutes), there occurs myriad fluctuations in the odds applicable to each “runner” in the upcoming race, as the proportion of the amount placed on a given “runner”, as a percentage of the total amount bet (i.e., all bets), changes. Typically a “Tote Board” displays, in a listing of race entrants ordered by their post position, the odds then currently applicable to each “runner”, and this odds information is typically “refreshed” frequently, such as every minute or two.

A traditional racetrack tote board will begin publishing current odds, and win-place-show totals for a particular event, about 20 minutes prior to the start of the event. In addition the so-called “morning line” developed for each runner by a professional handicapper is also usually displayed on the tote board. However, each time that a bet is subsequently placed on any runner in the race, all values earlier published become correspondingly inaccurate and obsolete. Consequently, traditional tote-boards publish updated odds numbers on a predetermined schedule, such as every 30 seconds, and usually by overwriting the information previously displayed. The unfortunate result, for the wagering public, is that, with such overwriting, traditional tote boards deprive the racing public of “historical” information including information that might reveal significant trends in betting behavior in the minutes preceding the racing event.

The prior art includes isolated examples of tote board systems capable of displaying a modicum of historical data, but the presentation of such data in these prior art systems has been crude and limited. In general, the potential usefulness of the available data streams of pari-mutuel data, as sources of data for the derivation and the imaginative display of parameters of interest to the racing public, has heretofore been unappreciated and ignored.

In contrast to prior art tote board systems, it is a principal objective of the present invention to provide a tote board system specifically adapted to store all pari-mutuel data received as a data stream from a racetrack tabulator system, and thereafter to use all of that stored pari-mutuel data as source data, both for “real time” dynamic displays of historically changing pari-mutuel information, and as raw data for a variety of analytical processes that produce novel forms of wagering information likely to be of interest to the wagering public.

The experience of viewing the changing of odds on a tote board can be disconcerting to bettors. Not uncommonly, a bettor will place a bet on a selected runner at given odds only to see the odds on that runner be substantially reduced as the race approaches. For example, the prospect of a 10:1 return on the selected runner in the event of a win, as based on the odds when the bet was placed, can rapidly be reduced to the prospect of a reduced 5:1 return (on money now committed) if by post time a surge of betting by others on the same runner doubles the proportion of bets placed on this runner relative to the sum of all bets placed.

This uncertainty regarding the “final odds”, that is, the odds that will be in effect when the race starts and the betting windows have closed, causes many bettors to delay placing their bets until immediately before the race, in order to wager while having in hand the best available information regarding the potential payback of the bet. This practice can result in lost opportunities to place a bet if too many users rush to the betting window immediately prior to the race. Besides fewer bets and a lower total amount wagered, from which the racing facility receives a percentage, this “last minute” practice also increases the instability in the odds offered in a pari-mutuel system.

Serious bettors are understandably eager to have at hand the best available wagering information. Providing bettors with additional wagering information, clearly pertinent to the value of their wagers, will therefore increase bettor interest and enjoyment. Currently, the principal source of odds information available to bettors at a racetrack, regarding odds on the runners in each race, are the tote boards which are strategically placed throughout the spectator areas at a racetrack, and which display the current odds information. (Another source of odds information is the “racing form”, a printed publication distributed to spectators, containing a list of entries for each race and also the so-called “morning line”, which is a starting list of odds developed by professional handicappers based on their general racing knowledge and their study of the pedigree and racing histories of the various entries).

The prior art reflects a few attempts to provide racetrack and off-track bettors with some additional odds information. Notably, U.S. Pat. No. 5,564,977 issued to R. Algie discloses a system that receives the same data stream of odds information that feeds the tote boards, and uses that data stream to provide bettors with a display of limited historical odds data. Specifically, the Algie system provides a display comprising three or four columns of historical odds data pertaining to a list of race entrants.

In the operation of the Algie system, a first column displays, for each race entrant and on a line with the entrant's listing in its post position order, odds data that refreshes frequently (every one or two minutes). After a set period in the order of 5 minutes, the display on this first column locks at the last received list of odds, and a second column to the right of the first column then takes over the display of rapidly refreshed odds data. On the expiration of another set period (say, 5 minutes) this second column in turn “locks in” its last received odds listing, and a third and last column to the right of the second column takes over the rapid refresh display of odds data, until it too “locks in”, this time with the “final odds” upon the start of the race. Thus the Algie system provides the betting public with some limited “historical” odds information, even as the currently active column displays the currently changing odds in the manner of the traditional tote board.

An Australian commercial website, www.tabracing.com, which provides online wagering services, enables its subscribers and the public to access a virtual tote board that, like the Algie system of the '977 patent, displays, for each runner in a selected race, three (3) historical odds records, spaced an hour apart. Another current website that offers online wagering services, http://www.brisnet.com/, provides multiple virtual tote boards that can be viewed at the same time. In lieu of the usual display of odds for each runner, the brisnet.com virtual tote boards displays instead a single odds-derived value, to with, the percentage of total wagers allocated to the selected runner. None of these prior art systems, however, provides bettors with access to comprehensive historical odds data, to historical data regarding dollar amounts wagered, or to any wagering information derived from processed feeds of pari-mutuel wagering data. Also, no known prior art system comprises means for the graphical display, in real time, of trends in wagering activity, let alone provide users with means for selecting from a variety of modes for displaying wagering data and trends in real time.

Furthermore, no pari-mutuel tote-board system is known to exist that provides a bettor on pari-mutuel events with means to develop, at will, custom “wagering systems” adapted to employ “historical” wagering data concerning an ongoing event, for the evaluation of potential bets, and/or that enable a user to create triggering mechanisms for actual bet placements across multiple runners and tracks. Additionally, no system is known to exist that provides users with a means to gather and display wagering data of exacta, quinella and trifecta values, or to provide any historical information regarding these more exotic forms of pari-mutuel wagers.

### SUMMARY OF THE INVENTION

It is a principal object of the present invention to provide a pari-mutuel tote board system that conveys to bettors a wealth of presently unavailable “historical” data regarding the wagering history of a selected ongoing or past pari-mutuel event, and to present the data in attractive graphical displays that convey pertinent wagering information effectively both in text and in visual images, including color-coded images.

Conventional pari-mutuel tote boards operate using a data stream of current wagering information, but limit their function to presenting bettors with only the most current odds data. As additional bets are made, the displayed information is typically overwritten within one or two minutes. Thus the context in which the newly displayed data arose, here called the “historical” data, is generally discarded. It is an object of the present invention to store such historical wagering data, and to render it, and various derivative forms of the data, accessible to bettors.

It is a principal object and result of the present invention to make available to users of the system, such as bettors on track racing events, displays of processed pari-mutuel wagering data (derived from track wagering data streams time-stamped and stored on receipt) that comprises a wide variety of continually updated displays of historical data, including odds trending data that may be individualized for each race participant or for a selected group of race participants. The selections of data screens thus made available to users enable a user to rapidly switch, for example, from a display of the wagering history concerning the next upcoming race and comprising data for all race entrants, to a display setting forth, for example, the wagering data applicable to any entrants for which a change in the “to win” payout odds have exceeded a user-selected set of threshold criteria, all in real time in the minutes preceding the start of a race on which the user is considering placing a wager.

It is thus a further object of the invention to perform various operations on stored historical data, concerning wagering on a pari-mutuel event. This stored data can be manipulated by computer programs, examined by computer algorithms, and analyzed for patterns. Particular mathematical operations on such stored data will yield results having immediate usefulness to bettors as they place bets prior to the race for which such data was generated, and these and other results of operations on such data will have continuing significance and usefulness to bettors even after the pari-mutuel event is over, as analysis tools useful in planning betting systems.

It is accordingly another object of the present invention to make available to users of the system, such as bettors on track racing events, sets of time-stamped data derived and/or processed from track wagering data streams (last odds, amount wagered totals, etc), in a form that facilitates the users' creation of custom “betting systems” designed by the user to evaluate alternative betting decisions in light of user-determined constraints such as risk and financial limits.

It is a further and related object of the present invention to provide users of the system with the wagering data and means for developing betting systems and strategies, and means for “back-testing” any such system or strategy for example using data stored from prior event data feeds.

It is a related object of the present invention to provide a system comprising means for a user to capture and store, and thereafter to use as and when desired, all wagering data, bets placed or contemplated, final outcome of the race and resulting profit/loss data, regarding a multiplicity of races run at a multiplicity of racetracks.

It is yet another object of the present invention to provide a pari-mutuel wagering system comprising bet triggering means, whereby bets may be automatically placed in a timely and effective manner in accordance with a betting system that employs historical wagering data processed by the system from a live feed of an ongoing event.

It is yet another objective of the invention to provide the betting public with an educational tool, the use of which will assist individual bettors in developing skills at evaluating the comparative merits of alternative wagers, and the tactical and strategic skills needed to place bets in ways that optimize the likelihood of success. Thus, practiced use of the informational tools provided by a system according to the present invention will enable a bettor to test theories regarding the identification of objective factors associated with successful wagering, and to focus wagering decision making on information and factors that experience has shown to be pertinent.

It is an important object of the invention to provide bettors on pari-mutuel events with a tote board system that gives each bettor full control, within a universe of presently unavailable and yet pertinent historical wagering data, to select which data to view, to view such data in any of several alpha-numeric and graphical forms, and to manipulate the data at will.

It is a further object of the invention to provide bettors on pari-mutuel events with tote board display means capable of displaying in real time wagering data, including potential pay-off data, for any potential “exacta”, “quinella” or “trifecta” wager of interest to the user. The pre-race odds on exacta (picking the 1^{st} and 2^{nd} runner—order dependent), quinella (picking the 1^{st} and 2^{nd} runner—order independent) and trifecta (picking a 1^{st}, 2^{nd} and 3^{rd} runner—order dependent) wagers are particularly volatile due to the complexities inherent in combining multiple runners and order of runners in a single wager. The ability of a would-be bettor to capture in real time, and to combine as needed to develop exacta, quinella and trifecta odds and pay-off figures, the odds applicable to each among any selection of runners, empowers such a bettor to develop wagering systems based on the manipulation of such data. These “exotic” bets, which are potentially more lucrative than simple bets due to their higher risk, are usually the province of well educated and more affluent bettors, to whom the system of the invention is expected to have particular appeal, and its use by such bettors should yield more bets and thus more money in the pool totals.

Lastly it is an object of the invention to provide a system which provides a user with means to design, and to test and refine, on the basis of historical wagering data provided by the system, one or a plurality of wagering systems or “methods” based on performance markers drawn from the analysis of such historical wagering data, and that preferably further comprises trigger alert means whereby a selected wagering system is enabled to generate alerts to the user (for example in the form of audible or viewable messages to the user for manual execution) or automatically to trigger bet orders on an entrant or entrants in a racing event, thereby providing effectively instantaneous execution in response to a detected opportunity determined in accordance with criteria associated with the wagering system.

Described is a system and method for the capture, storage, processing, manipulation, utilization and display of data regarding pari-mutuel events. Wagering information data streams obtained from conventional sources are captured, stored, manipulated and processed to yield derivative data that can be displayed in alphanumeric and/or color-coded graphical representations and/or utilized in real-time. The displays and associated data generated by the system empower a user to create, display, store, and back-test wagering strategies and algorithms, including wagering algorithms that may be automatically effectuated by the system to generate actual bets and to calculate profit and loss for each bet, runner and event.

One embodiment of the invention is a system for processing pari-mutuel wagering data and for distributing and displaying processed pari-mutuel wagering data, comprising:
(a) means for receiving, time-stamping and storing a pari-mutuel data stream concerning at least one racing event;
(b) processing means, associated with the means for receiving, time-stamping and storing a pari-mutuel data stream, adapted to mine and to process data from the pari-mutuel data stream;
(c) at least one display means adapted to display selectively any of a plurality of potential alpha-numeric and graphic representations of data processed by the processing means and derived from the pari-mutuel data stream, the potential representations of data collectively comprising at least:
   (i) a display panel that displays historical wagering data concerning a racing event, including “odds to win” data for any selected runner in the event upon the occurrence of each of a plurality of time benchmarks preceding the start of the racing event; and
   (ii) a display panel that displays, for any selected runner in a racing event, the amounts wagered on the runner to win the racing event, upon the occurrence of each of a plurality of time benchmarks preceding the start of the racing event.

Preferably, in the above-described system, the potential representations of data comprise a display panel that displays, for any selected runner in a racing event, the incremental difference in the amounts wagered on the runner to win the racing event within two equal and adjoining time periods preceding the start of the racing event.

Preferably, in the above-described system, among potential representations of data there is a panel that displays historical wagering data concerning all runners entered in a racing event, wherein odds data at each of a plurality of time benchmarks preceding the start of the racing event is presented in the form of adjoining columns and, within each column, the data entry regarding any one runner is positioned vertically according to the runner's odds ranking for the time benchmark represented by the column.

Preferably, in the above-described system, in each of a plurality of columns of historical wagering data, the odds data associated with any particular runner is consistently presented as an alpha-numeric number against a colored background having a color associated with the post position of a particular runner.

Preferably, in the above-described system, the representations of pari-mutuel data comprise at least one display panel wherein changes in wagering data associated with any one or more selected runners in a racing event are presented graphically against a time line representing a plurality of time benchmarks preceding the start of a racing event.

Preferably, in the above-described system, there is further included network means enabling individual users to communicate interactively with the system and thereby to select and display, on display means controlled by the user, any of a plurality of representations of pari-mutuel wagering data concerning a racing event.

Preferably, in the above-described system, there is further included means for an individual user to access from the system stored wagering data concerning a concluded racing event, including historical wagering data for all runners in the concluded racing event for a plurality of time benchmarks preceding the start of the concluded racing event.

Preferably, in the above-described system, there is further included means for an individual user to access from the system stored wagering data concerning a plurality of concluded racing events, and to obtain from the stored wagering data a user-determined selection of wagering data specific to any specific runner or runners concerning at least two racing events.

Preferably, in the above-described system, there is further included triggering means for automatically notifying a user that wagering data dynamically received and processed regarding an ongoing racing event has met a wagering trend condition set by the user.

Preferably, in the above-described system, there is further included among potential representations of wagering data, a panel that displays estimated “pay-off” amounts for any potential exacta, quinella or trifecta wager made regarding the racing event.

Yet another embodiment of the invention is a pari-mutuel toteboard display system comprising:
means for receiving, storing and processing a pari-mutuel data stream;
at least one toteboard display screen for displaying singly or in combination a plurality of running history display panels including:
a running odds total panel,
a running odds delta panel,
a running win total panel,
a running win delta panel,
a running place total panel,
a running place delta panel,
a running show total panel, and
a running show delta panel.

Preferably, in the above-described toteboard display system, there is further included among display panels available for display on the toteboard display screen,
a running odds divisor panel,
a running win divisor panel, and
a running place divisor panel.

Preferably, in the above-described toteboard display system, there is further included user control means and a user selection panel comprising panel menus and user-actuated graphical tools, whereby individual users by employing the user control means are enabled to make display panel selections from display panel menus presented on the user selection panel.

Preferably, in the above-described toteboard display system, there is further included means for an individual user to select for display, from any running history panel, wagering data pertaining to a selection of one or more entrants in a racing event.

Yet another embodiment of the invention is a pari-mutuel toteboard system for use in an off-track betting facility, comprising:
means for receiving, storing, and processing a plurality of pari-mutuel data streams concerning a plurality of racing events held at a plurality of racing facilities;
at least one large screen toteboard display screen for public viewing by customers of a off-track betting facility, at least one display screen being adapted to display a selection from a plurality of running history display panels concerning at least one selected racing event including a color-coded running odds total panel, a running estimated pay-outs panel, and a running delta to win panel; and
control means for use by the operator of an off-track betting facility to select the panels to be displayed on the display screen at any time and the time sequences to be employed in displaying running history data on any running history panel.

Preferably, in the above-described pari-mutuel toteboard display system, there is further included a plurality of user terminals equipped with display means and user control means, whereby individual customers of a the off-track betting facility may select to view wagering data concerning a selected racing event and thereafter select, access and view any of a plurality of display panels concerning the selected racing event including a running odds total panel, a running win total panel, and a running estimated pay-out total panel.

### BRIEF DESCRIPTION OF THE DRAWINGS

FIG. 1 (a-m) illustrates a conventional race track tote board display sequence, from “20 min. to post” to a “Post” display at the start of a racing event.

FIG. 2 illustrates a user screen as displayed in a system according to the present invention upon user selection of a “running odds” display.

FIG. 3 illustrates the “running odds” panel from the screen of FIG. 2.

FIG. 4 illustrates the “current odds and totals” panel from the screen of FIG. 2.

FIG. 5 illustrates the “potential payout” panel from the screen of FIG. 2.

FIG. 6 illustrates the user selection panel from the screen of FIG. 2.

FIG. 7 illustrates a “win running delta” screen corresponding to the racing event displayed in FIG. 2.

FIG. 8 illustrates a “win running divisor” screen corresponding to the racing event displayed in FIG. 2.

### DETAILED DESCRIPTION OF PREFERRED EMBODIMENTS

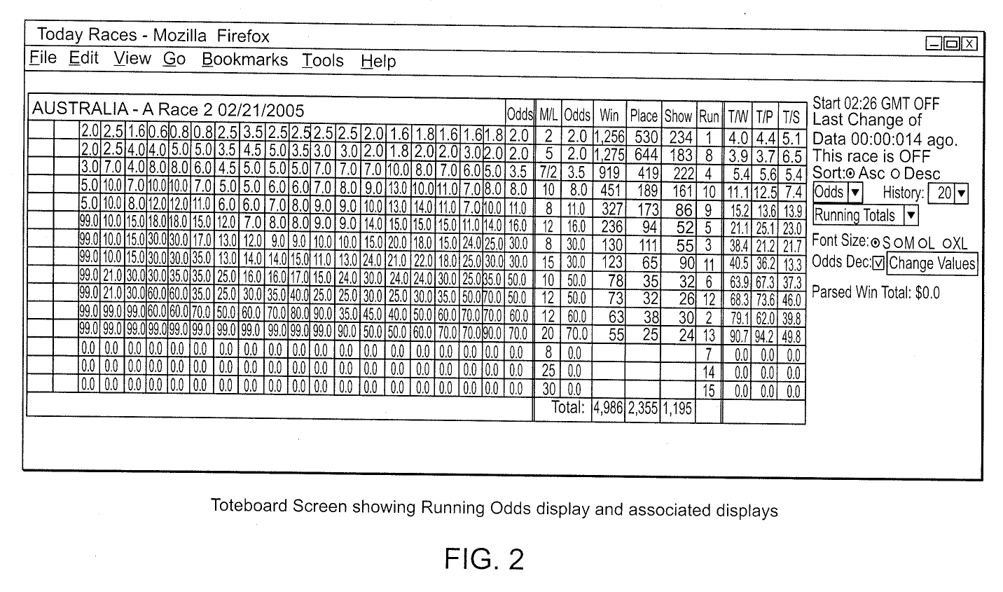

Referring to FIG. 2, the system of the invention comprises a Toteboard Display Screen for displaying to the user panels of data selected by the user from among a plurality of different panels of data pertinent to wagering on a track racing event, such as a horse race, a greyhound race, or the like.

The panels of data made available for viewing by a user comprise collections of data that principally include wagering data derived from streams of pari-mutuel wagering data generated and published in real time by race track operators. As is well known, race track operators collect pari-mutuel wagering data from bettors at their race track, display such data on tote-boards at their race track, and also make such data available in real time, via rapid communications links, to consumers of such data, notably including, for example, to operators of off-track pari-mutuel betting facilities. In this application, such streams of real time wagering data as published by a race track operator are referred to as “track pari-mutuel data streams”.

The present system may be adapted for use as an internet web-enabled system, as a (wired or unwired) system local to a single facility (such as the race track generating the original track wagering data stream), a proprietary network operated for example by a gambling casino, or indeed in any other context in which the use of such a system may be of interest to the wagering public, and to commercial (and governmental) operators catering to the wagering public.

It is an important feature of the present system that processed pari-mutuel wagering data is made available to users effectively “in real time”, that is, substantially instantaneously following the receipt and time-stamping by the system of an updated segment of track pari-mutuel wagering data, which is itself normally published by a track operator or a track-affiliated totalizator operator in rapidly updated segments within moments following the conclusion of each segment (typically at one minute intervals).

It is a further important feature of the present system that each segment of updated track pari-mutuel wagering data is stored by the system, along with time stamp and other identification and processing data, to permit the continued availability and use of such “historical” wagering data, at will by each user and by the system, for applications of interest to the wagering public as further described below.

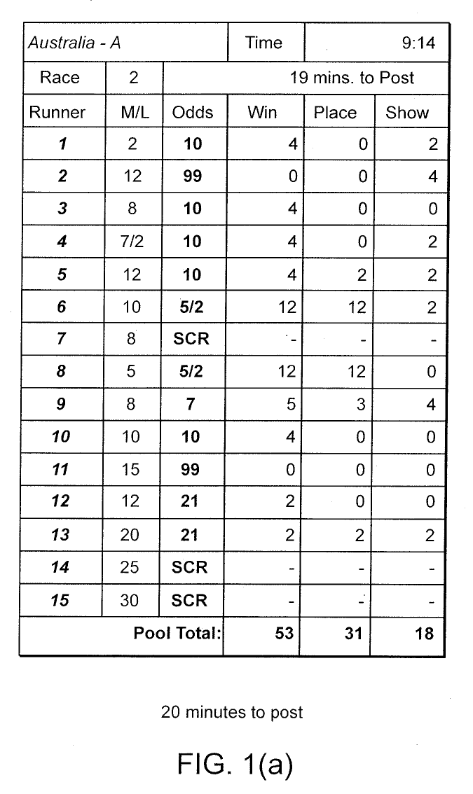

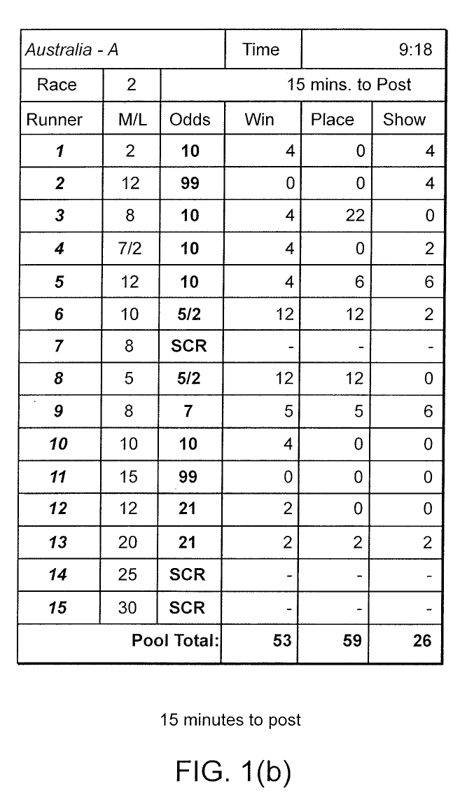

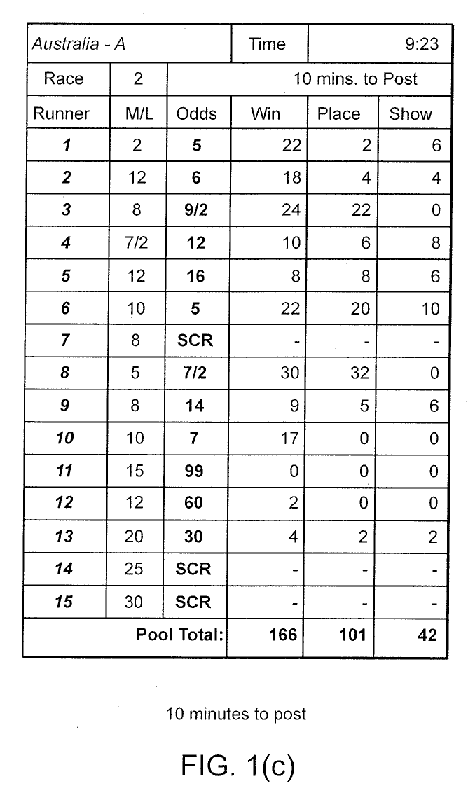

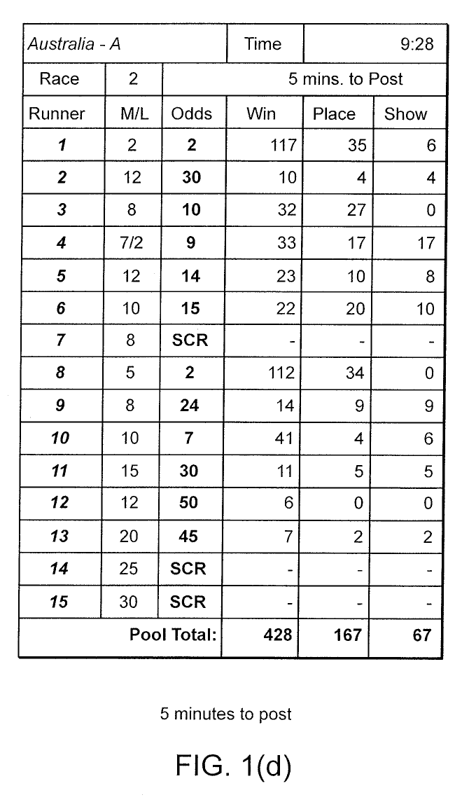

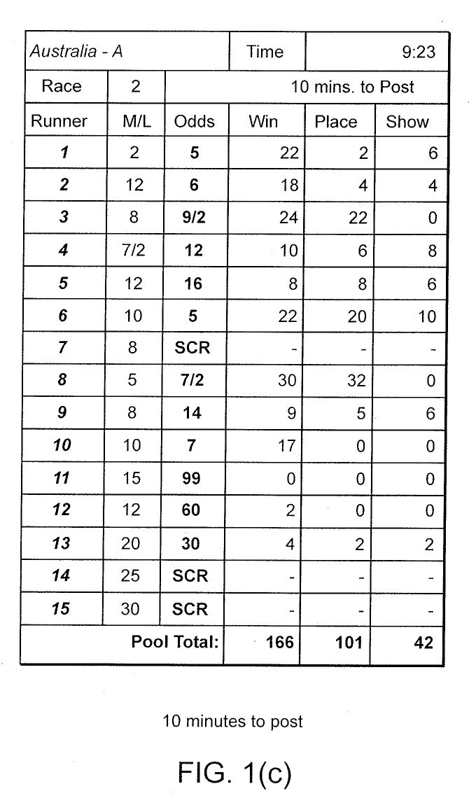

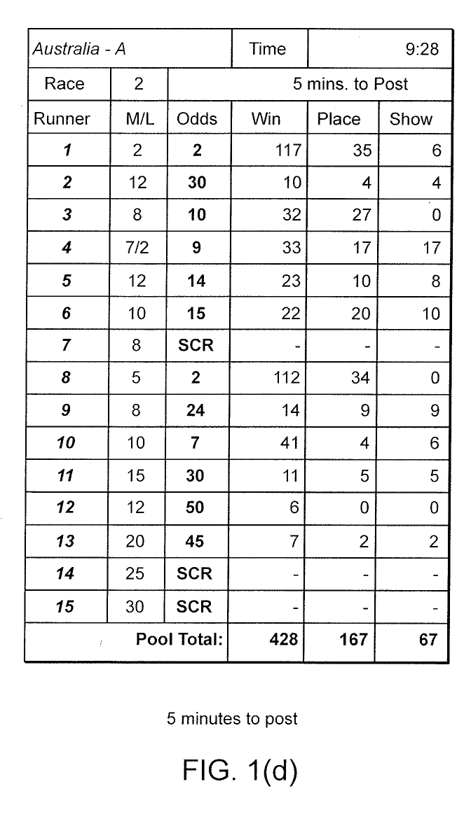

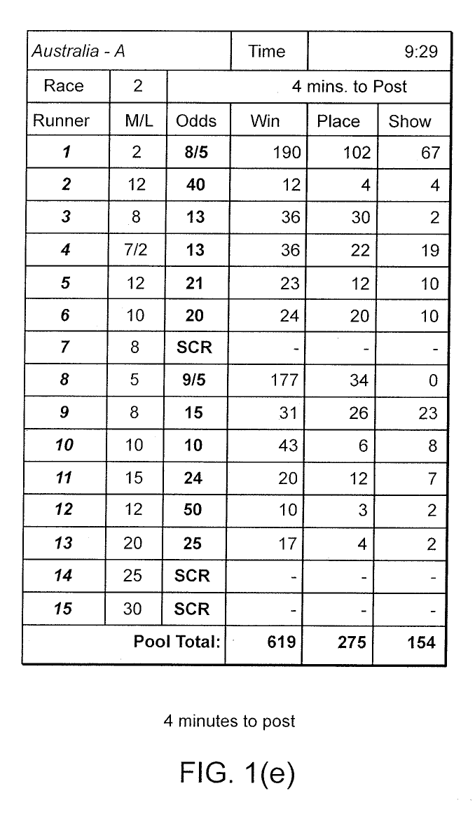

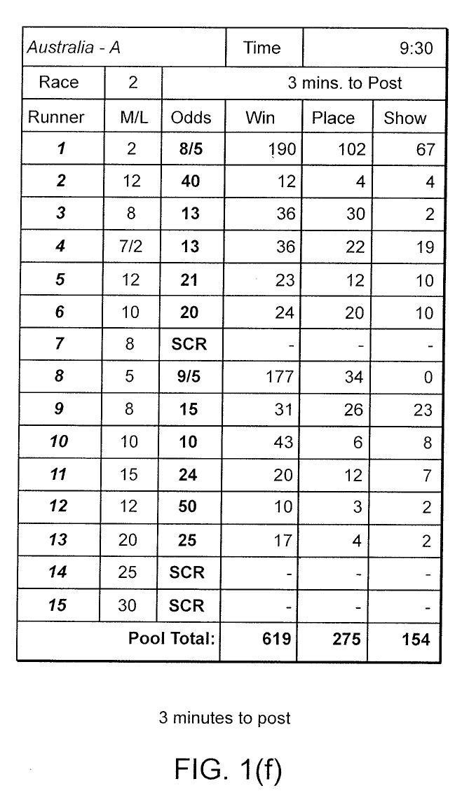

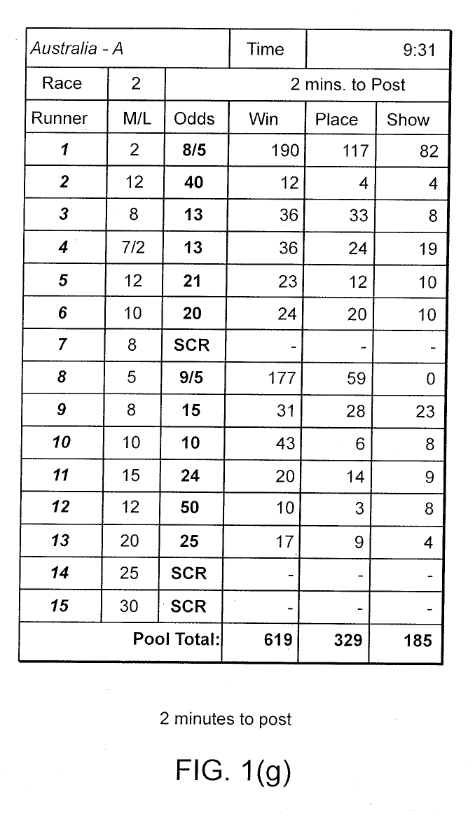

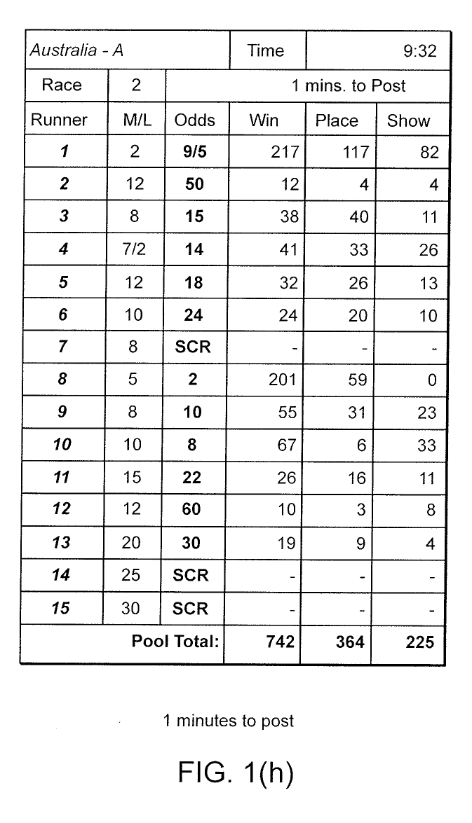

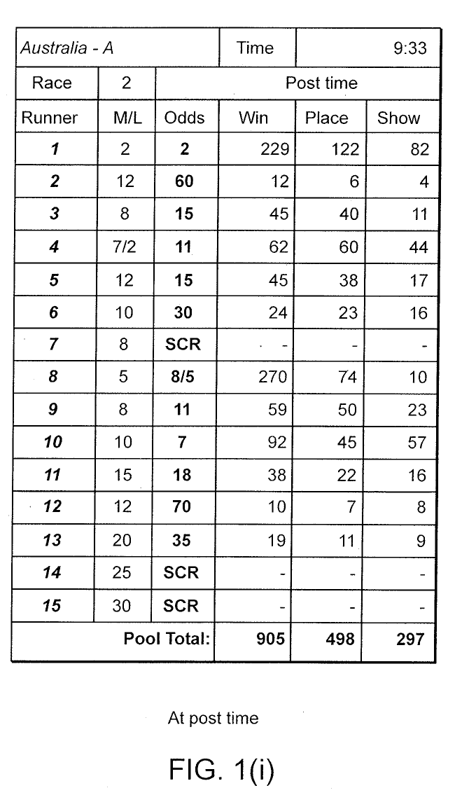

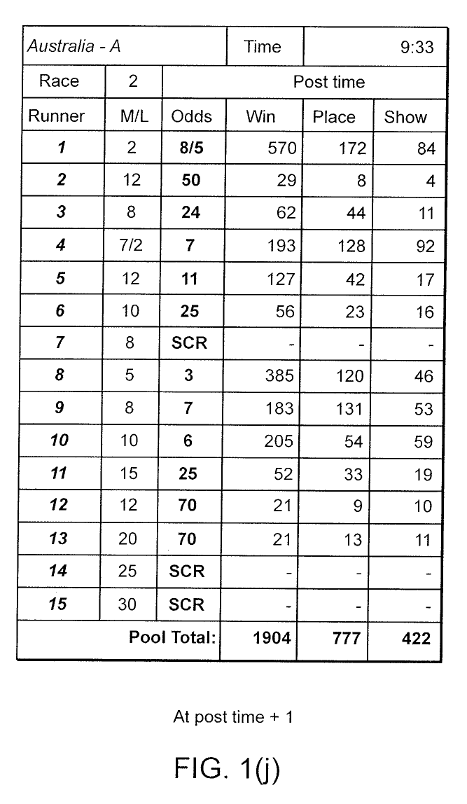

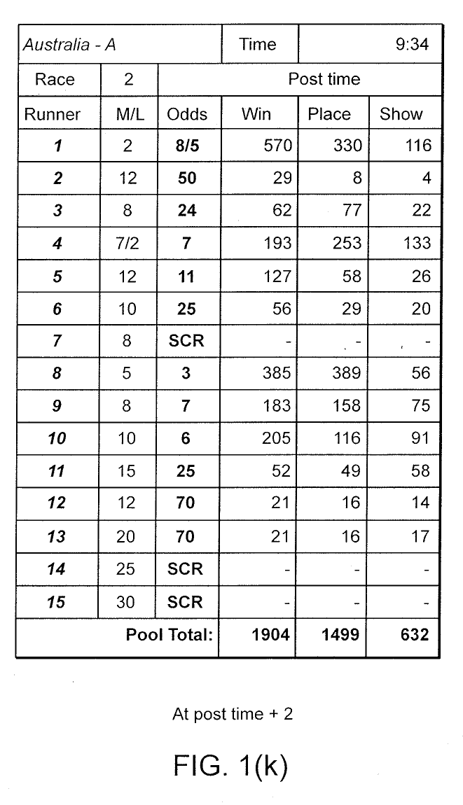

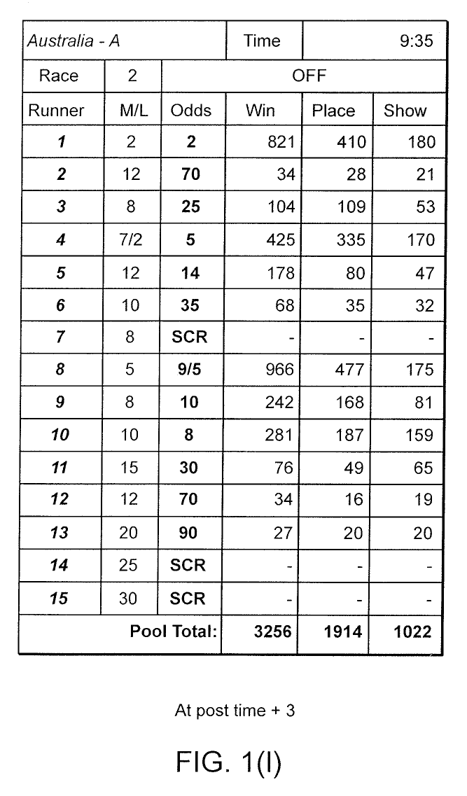

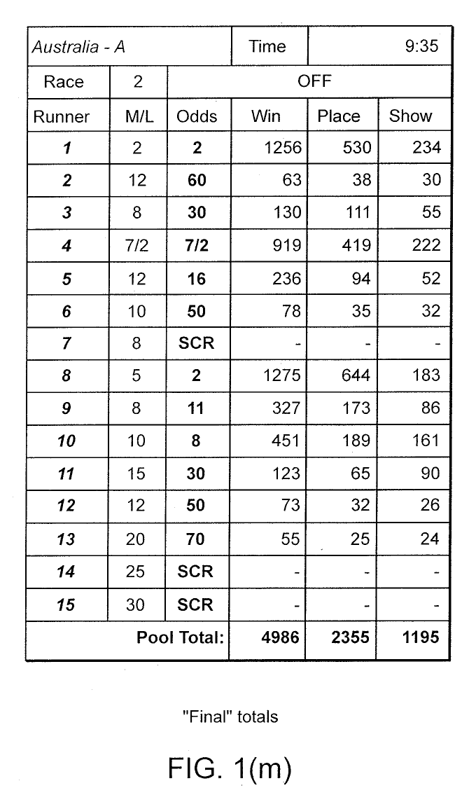

The information made available to the wagering public by the present system is vastly greater than that presented in a traditional race track tote-board. As shown in FIG. 1 (a-m), a traditional tote-board presents the public only with current, static pari-mutuel data, which is erased as the tote-board information is updated, typically every minute or so. The sequential views, (a) to (m), of a conventional tote-board, shown in FIG. 1, illustrate the rapidly changing odds applicable to each entrant in the race, and the lack of means on the tote-board that would enable a viewer to retain this history in mind, and to use it as an aid in making wagering decisions.

The traditional tote-board design, as shown on FIG. 1 and used generally at race tracks, displays only the current odds data, with no historical data whatever. Some prior art systems, for example as shown in U.S. Pat. No. 5,564,977, present very limited historical data, specifically odds data for a few prior time segments, in columns adjoining a list of race entrants in their post position order. However neither the traditional tote-board nor any other known prior art system provides users with the breadth and depth of processed historical wagering data that the present system makes available to the wagering public.

The present system employs, as raw data subject to processing and manipulation, the same track pari-mutuel wagering data streams that are the source data for screens (a) through (m) of the conventional tote-board illustrated in FIG. 1. Study at leisure of FIG. 1 screens (a) to (m) demonstrates that, over the course of the sequential time segments leading to the start of the race event illustrated in FIG. 1, a great deal of “data movement” occurred, evidencing a comparable degree of uncertainty in the “market” of wagering decisions reflected in these screens.

In direct analogy to the stock market, the storage, capture and analysis of historical “market” data pertaining to this, or any other, pari-mutuel event has substantial potential value to the serious participant in wagering on this event (and, possibly, also regarding future events involving one or more of the same race entrants). The present invention mines the track pari-mutuel wagering data stream, and processes the data stream data to generate, and to present to users of the system, alphanumeric and/or graphic displays of dynamic wagering information.

The present system stores the received strands or “streams” of track pari-mutuel wagering data streams, as time-sequenced snapshots of the pari-mutuel wagering process, and the collected, stored data lends itself readily to a variety of comparison, derivation and integration processes. As a result, users of the system can be presented with rich dynamic displays that comprise, in addition to classic tote-board elements, a variety of new data elements that convey information valuable to wager decision-making and which could not previously be calculated.

In order to explain the present system particularly to readers not familiar with pari-mutuel terms and practices, the following glossary defines terms commonly used on conventional race tote-boards:

TABLE 1
Definitions of common track racing terms.

| | |
|---|---|
| Race | The place (race location) and race number of a particular |
| | event for a particular day. |
| Runner | A particular competitor in a given race event - such as a |
| | horse (and jockey), a dog or any other entrant in a |
| | pari-mutuel race. |
| M/L | Morning Line - The Odds initially assigned to each entrant |
| | in each race, as typically published in a race publication (the |
| | so-called “racing form”) on each racing day. |
| Odds | The current odds on a particular entrant in a racing event, as |
| | calculated and published by the race track “tabulator” |
| | machinery. This odds figure is generally based on the fraction |
| | of all sums wagered that has been wagered on the entrant of |
| | choice. |
| Win | The total amount of money placed to date on the runner to win |
| | (to come in 1^{st} - to be the winner of the race) for this |
| | particular event. |
| Place | The total amount of money placed to date on the runner to |
| | place (to come in 1^{st} or 2^{nd} - to be one of the top two |
| | finishers of the race). |
| Show | The total amount of money placed to date on the runner to show |
| | (to come in 1^{st}, 2^{nd}, or 3rd - to be one of the top three |
| | finishers of the race). |
| Total | The total amount of money placed on all runners to win for |
| Win | this particular event. |
| Total | The total amount of money placed on all runners to place for |
| Place | this particular event. |
| Total | The total amount of money placed on all runners to show for |
| Show | this particular event. |
| Date | The date of this particular event - the date that the event |
| | occurred. |
| Start | The projected or approximated start date of the event. This is |
| Time | not the actual time of the event, but the time the event is due |
| | to start. |
| Last | The time lapse since the most recent update of the display. |
| Change | |

An important aspect of the present system is that it enables the derivation and calculation of new data elements of interest to the wagering public. These new data elements include, for example, the following items pertaining to the payouts projected upon the occurrence of specified results:

TABLE 2
Definition of “To Win”, “To Place”, and “To Show” concepts

| | |
|---|---|
| ToWin | “To Win” - An approximation of the payout odds for a |
| (T/W) | particular runner to win. For example, “$ 3.22” for runner |
| | No. 6 would indicate that, based on wagers to date, a win by |
| | runner 6 would return the sum of $3.22 for each dollar wagered |
| | on runner 6 to win. It is a calculation taking the total amount |
| | of money in the “win pool” for all runners, and dividing |
| | it by the amount of money in the “win pool” for the |
| | particular runner, as of the moment in time that the calculation |
| | was made: in the normal course of things, the “To Win” data |
| | will change with each update. |
| ToPlace | To Place - An approximation of the payout odds for a |
| (T/P) | particular runner to “place”, that is, to arrive second at |
| | the finish line. It is a calculation taking the total amount of |
| | money in the “place pool” for all runners, and dividing it |
| | by the amount of money in the place pool for the particular |
| | runner. |
| ToShow | To Show - An approximation of the payout odds for a |
| (T/S) | particular runner to “show”, that is, to arrive third at |
| | the finish line. It is a calculation taking the total amount of |
| | money in the “show pool” for all runners, and dividing it |
| | by the amount of money in the show pool for the particular |
| | runner. |

Another example of a new and important data element that the present system calculates is called, in this description, the “running delta to win”. This data element, or parameter, is directed to identifying trends in wagering on a particular race entrant, by measuring the difference between each two consecutive “win totals” for that entrant, that is: at what rate, over time, is money being wagered on that entrant to win the race? The system thus allows a user to see, “on the fly”, how the placement of “win” wagers on a particular runner is trending over time, in the pre-race wagering period.

By way of example, and referring to the conventional tote-board illustrated in FIG. 1 (a) to (m), runner # 1 had the following aggregate amount of dollars placed on him to “win”, at the close of the displayed betting periods: $4, $4, $22, $117, $190, $190, $190, $217, $229, $570, $570, $821, and $1256. Thus, the running delta for runner # 1 was: $0 (4−4); $18 (22−4); $95 (117−22); $73; $0; $0; $27; $12; $341; $0; $251; $435.

A bettor viewing this data might well find noteworthy the late, large infusions of “to win” wagers on runner #1 in the moments preceding the race (and in part tallied in the ensuing few minutes, to reach the “Final” numbers of FIG. 1(m)), notably if this “running delta to win” parameter for runner #1 was disproportionately larger than that of any other entrant in the race. To assist users in evaluating the significance of such data, and as described in more detail below, the system of the invention further permits a user (as one among many “derivative” functions enabled by the system), to set up a running comparison of the “running delta to win” function for any two or more runners, or indeed for the entire field, and to develop a running, color-coded, graphical presentation of this comparison: at a glance the user can spot developing trends.

In like fashion, the system of the invention enables the calculation of many other derivative values and functions from the captured “raw data”, that is from the pari-mutuel wagering data stream as received from a racetrack “tabulator”, and still others from newly derived numbers, or from a combination of both, even in conjunction with other “outside” values—each yielding yet other new “derivatives”. In particular, the system of the invention permits users to define, introduce, and develop alpha-numeric or graphic displays of their own “derivatives”, and thereby create an infinite number of new variations within the scope of the present system.

A tote board system according to the invention thus displays the same information to the end user as the current tote-board, and in addition it is capable of displaying a wealth of additional information of great interest to pari-mutuel bettors. In particular, the “Running History” displays generated in a system according to the invention allows users to see both the current values and all previous values (odds, win-place-show) for any and all particular runners over time. In addition the system enables the calculation and use (display, storage, etc.) of any derived values from the raw numbers.

Thus a central feature of the present invention that distinguishes it from the prior art is its provision of a “running history” displays, which displays to users “histograms” of selected data elements. That is, users are provided, on demand, with a display of the history, over time, of the changing values of selected data elements, notably including odds data, dollar amounts bet, etc. In particular, a preferred embodiment of the invention provides users with two principal types of histograms: the first focuses on changing odds data for all entrants in a pari-mutuel event, the second focuses on changing “amounts bet” data.

The system receives data from a racetrack tabulator service, or the like, in the form of packets of data that each constitutes a snapshot of current pari-mutuel information, and the system displays both the latest received snapshot and also past snapshots, thereby presenting viewers with a histogram or “running history” of values of interest. Thus, histograms provide a view of not only current information, but also of the history and movement of data over time. This historical data as collected and made available by the system to the user can then be used to do both simple and complex data mining and data analysis, by means of tools provided by the system, including tools that enable users to design, develop and use their own custom analytical programs for processing the provided pari-mutuel data.

In the following detailed description, the term “tick” is used with reference to changes in the value of particular data elements. A few comments may avoid confusion regarding the intended meaning of this term in this patent specification. In its simplest form, a “tick” is a change in any attribute. The system of the invention is intended to capture, save, and make available to users, any change whatever in any value streamed by a racetrack tabulator regarding a pari-mutuel event. Thus in this description of the present invention, the term “tick” will be taken to mean, unless otherwise specified, any change in the value of any data element. For example, a “tick” will include any change in any value as displayed on the current tote-board, for any runner, for any value (odds, win, place, or show). That said, it should be noted that, by agreement, a tick may be defined as a change in value that satisfies a particular criteria, such as a change in value that exceeds a specified percentage of the preceding value, or the like. Similarly, and in the context of a particular application, it may be desirable to define a tick to mean only certain changes in certain values, among a set of values. These variant definitions of the term “tick” are pertinent here, because the present system (as discussed in greater detail below) allows a user great flexibility in selecting values, or changes in values, for display (or other uses). In other words, the system permits the user both to select attributes of interest and also to define the quantum of change for the attribute (or attributes) that is to constitute a “tick”.

A user in creating a custom process using data provided by the system may choose to create novel displays that only include value movements defined by “ticks” having user-specified criteria, whether dimensionally or in value selection. Thus, for a given process, a user may want to define a “tick” to occur only when the odds change, or only when the win total changes, or perhaps a combination of an odds change with a “place total” change; another user might define a “tick” as a change on odds by at least 2 decimal points (0.2, or 20%).

Terms such as “up-tick” and “down-tick” are conventionally used, for example in discussions of movements in the value of stock prices, to refer to changes in value respectively considered positive and negative. In a track racing context, an “up-tick” is still a change in value of an attribute (such as odd, win-place-show values) in a positive direction. It is important to note, however, that with respect to values for odds, it is a decrease in the odds on a runner that occasions an up-tick: a movement in the odds on a runner from 10:1 to 3:1 is a positive movement, in the sense that it results from a comparative increase in wagering on that runner vis-à-vis other race entrants. However, a “win” up-tick occurs upon an increase in the total monetary amount placed on the runner to win. The present system enables users to set criteria for counting such “up-ticks” in a variety of ways, in order to identify changes in wagering momentum, persistency of bets, or stubbornness of the market.

Systems according to the present invention may be adapted to operate in tandem with conventional, current day racetrack tabulator services, which at the present time tabulate and publish wagering data regarding a racetrack event in pre-determined intervals (typically every 30 seconds). When dependent on such periodic data streams, a system according to the invention would not be capable of capturing individual bets, but only bets aggregated during each of the tabulator's 30 second “slices”. However, if a system according to the invention were connected directly to the “feed” into the racetrack tabulator, such a system could readily be made capable of capturing every single bet, individually, and of distributing that data to users, either as received or upon a set periods determined by each user (say, every 5 seconds for some users, 30 seconds for others, etc.). The ability to identify every single bet as made would carry with it the ability to categorize bets by amount, generating a set of values themselves subject to additional processing at the discretion of users: for example to identify trends involving only those wagers that are above or below a certain amount, or within a dollar range, thereby enabling (among other factors) a determination of the number of bettors affecting a significant change in odds.

Detailed discussion of the displays of wagering parameters enabled by the present invention will include references to the following parameters, which are defined in Table 3 below:

Running Odds Total

Running Odds Delta

Running Odds Divisor

Running Win Total

Running Win Delta

Running Win Divisor

Running Show Total

Running Show Delta

Running Show Divisor

Running Place Total

Running Place Delta

Running Place Divisor

These terms are explained in the following Table 3:

TABLE 3
Running History (Dated information) - Data Fluctuations

| | |
|---|---|
| Running | The “running odds total” is a historical (dated) |
| Odds Total | view of the odds as they stood at the close of each |
| | past tabulation period (or, alternatively, each “tick”): |
| | as odds change, they are displayed to the user, each |
| | set of data is offered to the user for a particular |
| | runner. Where conventional tote-boards display only |
| | current odds (and the morning line), this display is |
| | both continuous and ever changing, with each newly |
| | received odds value taking its place at the end of |
| | the “running odds total” line, and all earlier |
| | values moving one space to the left. |
| Running | The running odds delta is a “running” display |
| Odds Delta | of the margin of change between each displayed odds |
| | value and the immediately preceding odds value. |
| Running | The running odds divisor is the total of odds (sum |
| Odds Divisor | of all the odds) divided by the column value for |
| | this particular runner. As an example, if the odds |
| | were 0.8, 3, 3.5, 6 and 8 (ie 5 runners) - the total |
| | of the odds is 21.3. The running odds total of the |
| | 1^{st} runner (the one with odds of 0.8) is 21.3 |
| | divided by 0.8 or (21.3/0.8) = 26.6. The odds for |
| | the 2^{nd} runner is 21.3/3 = 7.1, 3^{rd} runner |
| | is 6.08, 4^{th} = 3.5, and 5^{th} = 2.66. This divisor |
| | really shows the relative “strength” of this |
| | value as it relates to the total. This is more |
| | obvious in the Running Win, Place and Show |
| | divisors. (see below) |
| Running | The “running win total” displays the total amount |
| Win Totals | of money placed on a particular runner, at the |
| | close of each tabulator period. |
| Running | The “running win delta” is a “running” display of |
| Win Delta | the margin of change between each displayed |
| | “win total” value and the immediately preceding |
| | “win total” value: For each tabulator period, |
| | this parameter sets forth the change in money |
| | placed on the runner since the last “tick”. |
| Running | The running win divisor is similar to the running |
| Win Divisor | odds delta, but it is the historical value of the |
| | ToWin (T/W) value as described in Table 3 above. |
| | The running win divisor is the total of the column |
| | WIN (win total) divided by the value placed on the |
| | runner to win. For example, assuming the values |
| | placed on a set of runners to be 794, 555, 294, 222 |
| | 184, 159, and 140 (for a total of 2348), the running |
| | win divisor for the 1^{st} runner (the one |
| | with a win total of 794) is 2348/794. or approximately |
| | 2.95. The remaining values are approximately 4.2, 8.0, |
| | 10.6, 12.8, 14.8, and 16.8. Here also, this parameter |
| | expresses the relative strength of a specific value |
| | relative to the total in the pool. |
| Running | Same as running win totals, but for show values |
| Show Totals | |
| Running | Same as running win delta, but for show values |
| Show Delta | |
| Running | Same as running win divisor, but for show values |
| Show Divisor | |
| Running | Same as running win totals, but for place values |
| Place Totals | |
| Running | Same as running win delta, but for place values |
| Place Delta | |
| Running | Same as running win divisor, but for place values |
| Place Divisor | |

FIG. 1 (a)-(m) illustrates a conventional race track tote board, as currently used at racetrack throughout the world. In addition to the “Morning Line” set by the track handicapper, the wagering information displayed on such a tote board comprises only a snapshot of the most current wagering information, and this information is overwritten every minute or so as a packet of updated information, i.e., a more current snapshot, is received from the track tabulator equipment. Referring to FIG. 1 (c), which illustrates the tote board display at “10 min. to post”, the top portion of the display identifies the racing event, here “Australia A, Race 2”, the time as 9:23, and the date stamp of the information as “10 min. to post.” The lower portion of the display comprises the following six columns, taken from the left side of the display:

Far left column 10 simply lists the runners in numerical order (1 to 15). Adjoining column 12 lists the “morning line” for each runner; the morning line is usually determined by a professional handicapper, who may be associated with the track, and it is intended to set forth a racing professional's estimate of the odds appropriate for each runner, based on their past performances, bloodlines, physical condition, and like factors.

Next on the right, Odds column 14 sets out the odds then applicable for each runner, based solely on a simple arithmetic calculation of win wagers placed to that time: for each runner, the odds value is simply that runner's share of the monetary amounts thus far wagered, rounded off to 2 significant figures. Thus, if the total of win wagers is $4,236 and the “runner No. 2 to win” wagers total $1,392, the proportion of win wagers held by runner No. 2 is 1,392/4,236, or approximately 32%. By longstanding convention, this odds percentage is converted to an inverse divisor format, as 3:1 or, more simply, 3.

Next to the right of Odds column 14 are 3 columns containing, for each runner, the monetary amounts thus far wagered on that runner. “Win” column 16 sets out the monetary amounts wagered on each runner to win the event. To its right, “Place” column 18 sets out the monetary amounts wagered on the runners to come in either first or second in the event. The last column on the right, “Show” column 20, sets out the monetary amounts, for each runner, of “to show” wagers, which cover any runner that completes the race in first, second or third place.

The 13 separate tote board displays which comprise FIG. 1 (a-m) constitute a partial selection of displays from a sequence in which the display contents typically would be updated every minute or so, with overwriting of earlier displayed numbers with the then current numbers. FIG. 1 (a) thus displays the odds and related data at a point in time 20 minutes prior to “post time”, the expected time for the start of the race. Subsequent displays show the odds and amounts wagered data as they stood at assorted later times before the start of the race, and conclude, with FIG. 1 (m), with the “Final” pari-mutuel data, computed using all wagers placed prior to the close of betting as the race began and typically displayed a few minutes following post time.

The illustrated selection of these snapshots, each of which was displayed to the public for only a minute or so, reflects sharp movements and changes of direction in the wagering on this racing event. For example, the odds on runner 1 were 10:1 at 15 minutes to post (see FIG. 1 (a)), but had risen sharply to 2:1 by “Post time” (FIG. 1 (i)). Conversely, and in the same period, the odds on runner 12 dropped from about 20:1 to 70:1. Close examination of the “Win-Place-Show” monetary totals columns, over the time sequence, discloses a variety of movements including shifts in the proportions, for any runner, of the amounts wagered for that runner respectively to win, to place, or to show.

The more closely the dozen snapshots that make up the FIG. 1 sequence are studied, the clearer it is that these displays contain a rich source of data regarding the dynamic history of wagering in that particular racing event. From the study of such data the experienced and knowledgeable racing fan is able to detect patterns and oddities that can serve as markers for a betting method: if detected by an astute bettor, such a pattern might cause that bettor to alter his own wagering behavior in that particular event. However, the rapidity with which conventional tote boards overwrite their displays with new and more current data renders it impossible for the most serious and careful racing aficionado to keep in memory the vast stores of data generated in the course of even a 20 minute wagering session, let alone to undertake any thoughtful analysis of that data.

Furthermore, the tote board data as conventionally presented on race track tote boards is very limited in kind: only the raw facts of how much has been wagered, to date, on each runner, to win, to place, or to show, and the Odds data resulting from the “To Win” wagering, are normally shown. No other values, “derivative” from this data, are displayed, though it is readily demonstrable that certain derivative values, easily calculated from the raw data, would be of great interest and value to the wagering public.

Referring now to FIG. 2, FIG. 2 illustrates an example of a display generated by a system according to the present invention, as viewable by a user of the system, for example on the user's own computer monitor, or on a large video screen in a facility operated by a racetrack or a track racing simulcast operator. The display illustrated on FIG. 2 comprises four side-by-side panels, as follows:

Leftmost “running history” panel 22 comprises a series of rows, equal in number to the number of runners entered in a selected racing event, and a series of columns, one for each time-stamped “tick” of the tabulator data stream selected for display. The “running history” panel of display 20 can feature any one of a number of parameters of interest, including “odds”, “ToWin delta”, or “ToPlace Divisor”, among others (as further detailed below). In FIG. 2 the “running history” panel, as selected by way of example, is a “running Odds” display, and therefore the data entries shown on the “running history” panel of the display are entries of odds: each box sets forth the odds on a particular runner at a particular point in a sequence of time-stamped points between the start of wagering and the publication of “Final” post-race results. Additional details regarding this “running history” panel are set forth below.

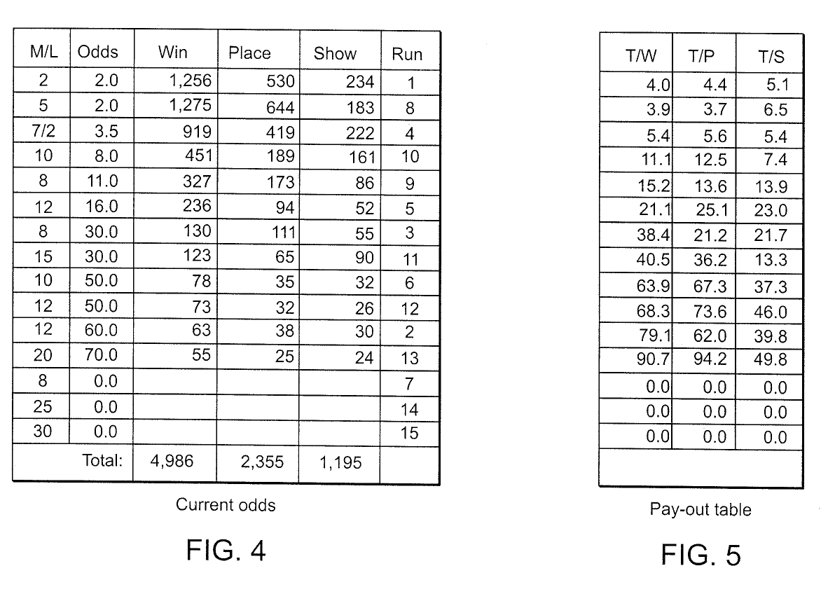

The panel to the right of the “running history” panel is “Current Board” panel 24, and it contains and displays essentially the same data now displayed at race tracks on conventional tote boards: that is, the morning line, the current odds on each runner, and the win-place-show monetary amounts wagered on each runner. A larger and more readable copy of panel 24 is illustrated in FIG. 4.

To the right of the Current Board panel is a new panel, “Payout” panel 26, consisting of three (3) columns headed respectively “T/W”, “T/P” and “T/S”. The entries in the data entry boxes of these 3 columns set forth approximations of the payout sums that would be applicable, for each one dollar wager (or corresponding base for other currencies), in the event of a first, second or third place finish by the runner associated with a selected data entry box, based on amounts wagered to that point. A larger and more readable copy of panel 26 is illustrated in FIG. 5.

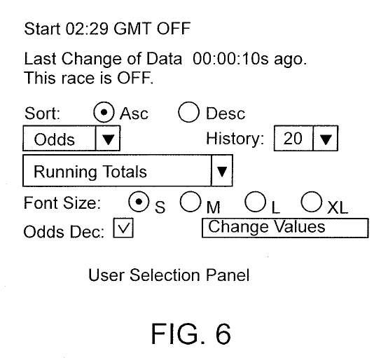

A fourth panel, to the right of Payout panel 26, is “User Selection” panel 28. This panel contains conventional tools, such as buttons, drop-down boxes, and data entry fields, for use by users of the system to request specific displays and to specify the display formats and attributes they desire. A larger and more readable copy of panel 28 is illustrated in FIG. 6, and the following Table 4 explains the function of the interactive tools illustrated on panel 28.

TABLE 4
User application interface - Selection criteria

| | |
|---|---|
| Sort | Gives the user the ability to sort by ascending or |
| Option | descending order |
| Number | Gives the user the ability to view the number (N) of time |
| of Slots | slots for the dated history section of the application |
| Display | Gives the user the ability to view the data in decimal (5.5) |
| Format | or divisor (11/2) format. |
| Font | Gives the user the ability to adjust the font size and |
| Sizes | appearance of the interface. |

It should of course be understood that the particular display arrangements and formats to be used in a system according to the present invention, including the size, shape, and physical arrangement, are subject to considerable discretion on the part of the system designer, and are in no sense limited to the particular forms of displays illustrated in this specification. In addition, it is noted that the effectiveness of visual displays depends to a surprising degree to the application of good visual design principles, a subject outside the scope of this description. (See, e.g., Edward R. Tufte, The Visual Display of Quantitative Information, Graphics Press, 1982).

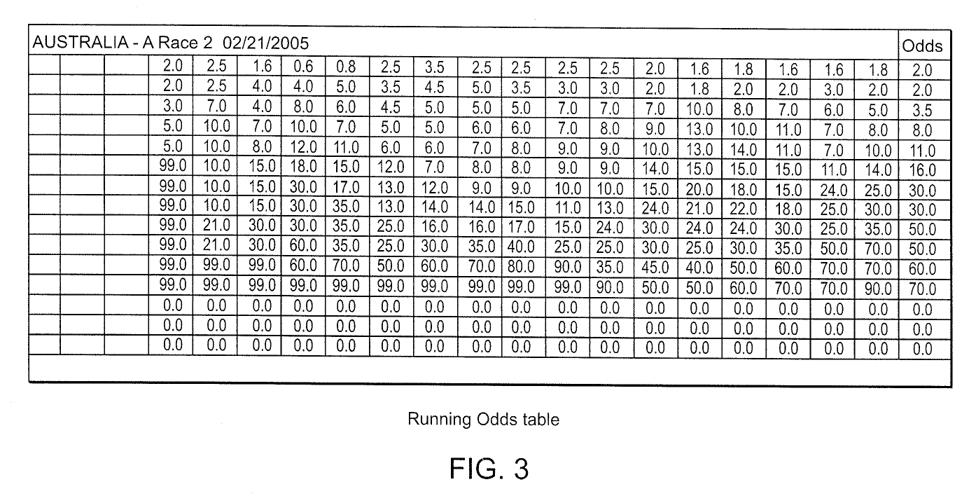

The “running history” panel 22 of FIG. 2 is shown in a larger format in FIG. 3. As this particular “running history” panel concerns odds data, it may now more specifically be called a “running odds” panel. The “running odds” format shown in FIGS. 2 and 3 illustrates a particularly favored embodiment for such a panel, which is characterized in two important and closely inter-related ways: first, it will be noted that the rows in this panel are equal in number to the number of entrants, but that specific rows are not assigned to specific runners; instead, in each column of newly received odds data, the data is presented from top to bottom either in ascending order of odds (best odds on top), or in descending order (worst odds on top), as selected by the user. Second, color coding is used to identify the position of each runner within each of the columns of panel 22, and thus to associate each data entry box with the runner to which its data pertains. The result is that “running odds” panel 22, in its tapestry of color patterns, conveys movements in the relative odds between runners graphically and instantaneously.

Racing associations and commissions commonly establish a set of standard colors to be associated with specific “post positions”, the numbered gates that hold the horses in the starting gate. For example, one such set of standard colors, established by the State of Wyoming Racing Commission, is as follows:

```
  1. Red
  2. White
  3. Blue
  4. Yellow
  5. Black
  6. Orange
  7. Purple
  8. Green
  9. Brown
10. Pink
11. Gold
12. Green and White
```

Other racing bodies have set different arrangements of “standard colors” to match post positions, but any such set of standard colors may readily be imported by the software of the system of the invention, as needed to conform to the conventions of each racing venue.

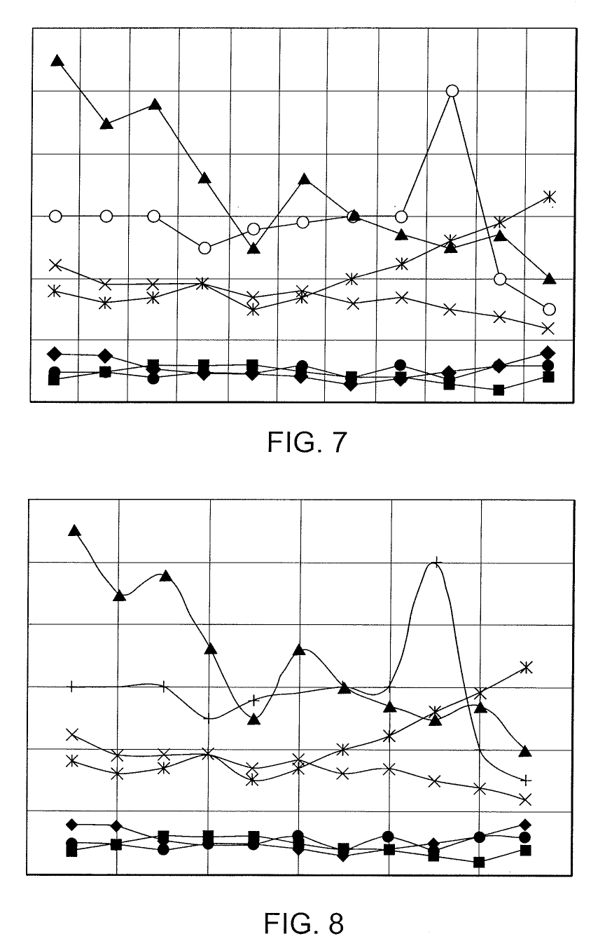

In preferred embodiments of the present invention, displays of data entries associated with particular runners are therefore normally set in data boxes against a background having the color of associated with the post position of that entrant. As shown in the illustrations of displays used in the present invention, in FIGS. 2-8, this use of data entry boxes having a background color matching the runners' own post position colors creates graphical displays that immediately convey to the viewer the position of each runner within a displayed table, be it of odds, amounts wagered, payout potential, or any other parameter of interest.

As stated earlier, the “running history” panel 22 shown in FIG. 2 may, instead of displaying a running history of odds, display a running history of other parameters of interest. For example a running history of amounts wagered “To Win”, or “To Place”, or “To Show”, may be displayed. Also, a variety of values that are derivatives of the basic values (odds, amounts wagered) may be displayed instead. One such value having particular interest is called in this description the “Delta To Win” parameter. This parameter consists of the difference, in monetary amounts, between the current total amount wagered on a runner and the last preceding value for this amount, dating from the preceding “tick” of the tabulator data stream.

As an example, the dollar amounts wagered on runner No. 1 as illustrated in FIG. 1 (the “conventional tote board” sequence) were as follows, over 13 time sequence points (a) through (m): $4, $4, $22, $117, $190, $190, $190, $217, $229, $570, $570, $821, and $1256. The change between each consecutive number is called the “Delta”, and a running history of this “delta” value as it changes as the racing event approaches can tell story. In this example, the “running delta” values for runner No. 1 are as follows (with the first delta, the difference separating the first two numbers, 4 and 4, being 0): 0, 18, 95, 73, 0, 0, 27, 12, 341, 0, 251, and 435.

Reviewing this series we see that the 4^{th} to the last value (341), 2^{nd} to the last (251) and last (435) collectively reveal a sudden, large upturn in the placement of wagers on this entrant. However, this information is simply provided by the system to the user without judgment, allowing the user to evaluate it and arrive at his or her own conclusions. One bettor may prefer a “worked-out system” that disregards the aggregate size of upturns in the market, and that measures instead how many “significant” upturns occur. In this example the number of significant upturns appears at first glance to be three, but a user of a system according to the invention is given discretion to define what is to constitute a “significant” upturn.

By measuring the number of significant upturns for each runner, a user of the system can now compare which runner has the most significant upturns compared to the rest of the field, and perhaps work out a system based on the comparison of upturns (or gaps) between a given runner (or runners) and the rest of the field.

Furthermore, a user of the system, by seeking out such “significant” values, can “work out” a selection of possible wagering “systems” and then proceed to back test their relative effectiveness by analyzing previously recorded outcomes of old races.

### Calculating Tentative Payouts

The calculations of potential payouts, based on wagers to date and before the close of betting, results in tentative payout figures only, subject to change as betting continues. However the calculation process is otherwise clear and certain, albeit somewhat complex. Also, the payout calculation algorithm applicable to particular racing event is dependent on rules and regulations that may be specific to the racing venue at which the event is run, or on other laws, rules and regulations otherwise applicable to the use of the system. In many cases the calculation algorithms are dictated by racing commission rules.

Conventionally, the basic approach in determining the Win Pool payout is that the amount wagered on the runner which finishes first is deducted from the “net pool” (equal to the gross win pool less the house “takeout”), the balance remaining being the profit; this profit is then divided by the amount wagered on winning runner, the resulting quotient being the profit per dollar wagered to Win on that runner.

Similarly, in determining the Place Pool payouts, the amounts wagered to Place on the first two runners to finish are deducted from the net pool, the balance remaining being the profit; the profit is divided into two equal portions, one being assigned to each winning runner and divided by the amount wagered to Place on that runner, the resulting quotient is the profit per dollar wagered to Place on that runner. (The algorithm is modified appropriately where a dead heat results in 3 runners qualifying as Place winners).

With respect to determining the Show Pool payouts, the amounts wagered to Show on the first three runners to finish are deducted from the net pool, the balance remaining being the profit; the profit is divided into three equal portions, one being assigned to each winning runner and divided by the amount wagered to Show on that runner, the resulting quotient being the profit per dollar wagered to Show on that runner. (Here also, a dead heat may require a modification of the algorithm).

The following are exemplary payout calculation algorithms, applicable in a venue controlled by racing commission rules that dictate explicitly the algorithms to be employed, though possibly permitting a choice between two forms of calculations, a so-called “Standard” calculation procedure, and a so-called “Net Price” calculation procedure. The important point, for purposes of this specification, is that computerized implementation of these complex-seeming payout calculation algorithms is in fact straightforward and may be programmed easily into application software for use in implementing a system according to the present invention. As needed the software implementing a system according to the invention will be therefore designed to incorporate such payout calculating algorithms as may be appropriate for the particular racing venue, and/or the particular commercial context(s) in which the system is intended to operate.

For example, applicable Racing commission rules may provide that:
1. All permitted pari-mutuel wagering pools shall be separately and independently calculated and distributed. Takeout shall be deducted from each gross pool as stipulated by law. The remainder of the moneys in the pool shall constitute the net pool for distribution as payout on winning wagers.
2. Either the standard or net price calculation procedure may be used.
   In such a regulatory context the “Standard” calculation procedure for pool profit splits may be as follows:
   “Standard” Win Pool profit determination for payout calculation:
   The “Gross Win Pool” consists of the Sum of all Wagers on all runners less the Refunds of wagers placed on the winning runner;
   The “House Takeout” is equal to the “Gross Win Pool” multiplied by an agreed Percent “Takeout”;
   The “Net Win Pool” is equal to the “Gross Win Pool” less the “Takeout”;
   Profit=“Net Win Pool” minus the “Gross Amount Bet on Winner”;
   Profit Per Dollar=Profit divided by the “Gross Amount Bet on Winner”.
   (Additional rules typically cover the handling of so-called “breakage”, that is, the remainders resulting from calculations that yield results other than integers; these rules also are readily implemented in software for use in a system according to the invention.)
   For example:
Sum of Wagers on all runners=$194,230.00
Refunds=$1,317.00

Gross Pool:
Sum of Wagers on all runners−Refunds=$192,913.00
Percent Takeout=18% (an assumed, typical figure by way of example)

Takeout:
Gross Pool×Percent Takeout=$34,724.34

Net Pool:
Gross Pool−Takeout=$158,188.66
Gross Amount Bet on Winner=$23,872.00

Profit:
Net Pool−Gross Amount Bet on Winner=$134,316.66

Profit Per Dollar:
Profit/Gross Amount Bet on Winner=$5.6265357

$1 Unbroken Price:
Profit Per Dollar+$1=$6.6265357
   “Standard” Place Pool profit determination for payout calculation:
   Profit, for the “Place Pool,” is the “Net Place Pool” less the aggregate gross amount bet on all place finishers to place. If the Place Finishers are two in number, the Place Profit is split one-half (½) to each; if they are three in number (in the event of a tie) the Place Profit is split in thirds. The resulting amounts are then respectively divided by the gross amount bet on each place finisher to yield two, or three, unique prices.
   For example:
Sum of Wagers on all runners=$194,230.00
Refunds=$1,317.00

Gross Pool:
Sum of Wagers on all runners−Refunds=$192,913.00
Percent Takeout=18%

Takeout:
Gross Pool×Percent Takeout=$34,724.34

Net Pool:
Gross Pool−Takeout=158,188.66
Gross Amount Bet on 1st place finisher=$23,872.00
Gross amount Bet on 2nd place finisher=$12,500.00

Profit:
Net Pool−Gross Amount Bet on 1st place finisher
Gross Amount Bet on 2nd place finisher=$121,816.66

Place Profit:
Profit/2=$60,908.33

Profit Per Dollar for 1st Place:
Place Profit/Gross Amount Bet on 1st place finisher=$2.5514548

$1 Unbroken Price for 1st Place:
Profit Per Dollar for 1st place+$1=$3.5514548

Profit Per Dollar for 2nd Place:
Place Profit/Gross Amount Bet on 2nd place finisher=$4.8726664

$1 Unbroken Price for 2nd Place:
Profit Per Dollar for 2nd place+$1=$5.8726664

### “Standard” Show Pool Profit Determination for Payout Calculation:

Profit, for the Show Pool, is the Net Show Pool less the aggregate gross amount bet on all show finishers to show. In a manner similar to the formula applicable to Place Finishers, the Show Finishers split profit one-third (⅓) and one-third (⅓) and one-third (⅓) when there are 3 Place Finishers, and the resulting amounts are then divided by the gross amount bet on each show finisher to yield the profit allocable to that finisher, resulting in three unique prices. The profit is split in fourths where there are four Place Finishers by reason of a dead heat, etc.

### Example

Sum of Wagers on all runners=$194,230.00
Refunds=$1,317.00

Gross Pool:
Sum of Wagers on all runners−Refunds=$192,913.00
Percent Takeout=18%

Takeout:
Gross Pool×Percent Takeout=$34,724.34

Net Pool:
Gross Pool−Takeout=$158,188.66
Gross Amount Bet on 1st place finisher=$23,872.00
Gross Amount Bet on 2nd place finisher=$12,500.00
Gross Amount Bet on 3rd place finisher=$4,408.00

Profit:
Net Pool less the Gross Amount Bet on 1st place finisher, the Gross Amount Bet on 2nd place finisher, and the Gross Amount Bet on 3rd place finisher=$117,408.66

Show Profit:
Profit/3=$39,136.22

Profit Per Dollar for 1st Place:
Show Profit/Gross Amount Bet on 1st place finisher=$1.6394194

$1 Unbroken Price for 1st Place:
Profit Per Dollar for 1st place+$1=$2.6394194

Profit Per Dollar for 2nd Place:
Show Profit/Gross Amount Bet on 2nd place finisher=$3.1308976

$1 Unbroken Price for 2nd Place:
Profit Per Dollar for 2nd place+$1=$4.1308976

Profit Per Dollar for 3rd Place:
Show Profit/Gross Amount Bet on 3rd place finisher=$8.8784528

$1 Unbroken Price for 3rd Place
Profit Per Dollar for 3rd place+$1=9.8784528

Similar calculations may be made for more exotic wagering combinations, including exactas, quinellas, trifectas, etc. All such wagering combinations invoke payout calculating algorithms that are readily implemented in computer software, and accordingly are readily implemented in designing the software that supports the “Payout” panel display in a system according to the present invention. Comparisons between individual odds on a given runner, in combination of odds on a pair of runners (exacta or quinella) can quickly be evaluated by the bettor as to the true value of said bet.

What is claimed is:

1. A system for processing pari-mutuel wagering data and for distributing and displaying processed pari-mutuel wagering data, comprising:
(d) means for receiving, time-stamping and storing a pari-mutuel data stream concerning at least one racing event;
(e) processing means, associated with said means for receiving, time-stamping and storing a pari-mutuel data stream, adapted to mine and to process data from a said pari-mutuel data stream;
(f) at least one display means adapted to display selectively any of a plurality of potential alpha-numeric and graphic representations of data processed by said processing means and derived from a said pari-mutuel data stream, said potential representations of data collectively comprising at least:
(i) a display panel that displays historical wagering data concerning a said racing event, including “odds to win” data for any selected runner in said event upon the occurrence of each of a plurality of time benchmarks preceding the start of said racing event; and
(ii) a display panel that displays, for any selected runner in a said racing event, the amounts wagered on said runner to win the racing event, upon the occurrence of each of a plurality of time benchmarks preceding the start of said racing event.

2. The system of claim 1 wherein said potential representations of data comprise a display panel that displays, for any selected runner in a said racing event, the incremental difference in the amounts wagered on said runner to win the racing event within two equal and adjoining time periods preceding the start of the racing event.

3. The system of claim 1 comprising, among potential representations of data, a panel that displays historical wagering data concerning all runners entered in a said racing event, wherein odds data at each of a plurality of time benchmarks preceding the start of the racing event is presented in the form of adjoining columns and, within each said column, the data entry regarding any one runner is positioned vertically according to said runner's odds ranking for the time benchmark represented by said column.

4. The system of claim 3 wherein, in each of a plurality of columns of historical wagering data, the odds data associated with any particular runner is consistently presented as an alpha-numeric number against a colored background having a color associated with the post position of said particular runner.

5. The system of claim 1 wherein said representations of pari-mutuel data comprise at least one display panel wherein changes in wagering data associated with any one or more selected runners in a racing event are presented graphically against a time line representing a plurality of time benchmarks preceding the start of a racing event.

6. The system of claim 1 further comprising network means enabling individual users to communicate interactively with the system and thereby to select and display, on display means controlled by the user, any of a plurality of representations of pari-mutuel wagering data concerning a racing event.

7. The system of claim 6 comprising means for a said individual user to access from the system stored wagering data concerning a concluded racing event, including historical wagering data for all runners in said concluded racing event for a plurality of time benchmarks preceding the start of said concluded racing event.

8. The system of claim 7 further comprising means for a said individual user to access from the system stored wagering data concerning a plurality of concluded racing events, and to obtain from said stored wagering data a user-determined selection of wagering data specific to any specific runner or runners concerning at least two racing events.

9. The system of claim 6 further comprising triggering means for automatically notifying a user that wagering data dynamically received and processed regarding an ongoing racing event has met a wagering trend condition set by the user.

10. The system of claim 1 further comprising, among potential representations of wagering data, a panel that displays estimated “pay-off” amounts for any potential exacta, quinella or trifecta wager made regarding the racing event.

11. A pari-mutuel toteboard display system comprising:
means for receiving, storing and processing a pari-mutuel data stream;
at least one toteboard display screen for displaying singly or in combination a plurality of running history display panels including:
a running odds total panel,
a running odds delta panel,
a running win total panel,
a running win delta panel,
a running place total panel,
a running place delta panel,
a running show total panel, and
a running show delta panel.

12. The toteboard display system of claim 11 further comprising, among display panels available for display on said toteboard display screen,
a running odds divisor panel,
a running win divisor panel, and
a running place divisor panel.

13. The toteboard display system of claim 11 further comprising user control means and a user selection panel comprising panel menus and user-actuated graphical tools, whereby individual users by employing said user control means are enabled to make display panel selections from display panel menus presented on said user selection panel.

14. The toteboard display system of claim 12 further comprising means for an individual user to select for display, from any running history panel, wagering data pertaining to a selection of one or more entrants in a racing event.

15. A pari-mutuel toteboard system for use in an off-track betting facility, comprising:
means for receiving, storing, and processing a plurality of pari-mutuel data streams concerning a plurality of racing events held at a plurality of racing facilities;
at least one large screen toteboard display screen for public viewing by customers of a said off-track betting facility, said at least one display screen being adapted to display a selection from a plurality of running history display panels concerning at least one selected racing event including a color-coded running odds total panel, a running estimated pay-outs panel, and a running delta to win panel; and
control means for use by the operator of a said off-track betting facility to select the panels to be displayed on said display screen at any time and the time sequences to be employed in displaying running history data on any running history panel.

16. The pari-mutuel toteboard system of claim 15 further comprising a plurality of user terminals equipped with display means and user control means, whereby individual customers of a said off-track betting facility may select to view wagering data concerning a selected racing event and thereafter select, access and view any of a plurality of display panels concerning said selected racing event including a running odds total panel, a running win total panel, and a running estimated pay-out total panel.
